(19) United States
(12) Patent Application Publication
(10) Pub. No.: US 2021/0085123 A1
(43) Pub. Date: Mar. 25, 2021

(54) COFFEE MACHINE WITH COFFEE BEAN GRINDING FUNCTION

(71) Applicants: Zhongyu SHI, ZHEJIANG PROVINCE (CN); Shukuo LIU, ZHEJIANG PROVINCE (CN); Yinlu WANG, HENAN PROVINCE (CN)

(72) Inventors: Zhongyu SHI, ZHEJIANG PROVINCE (CN); Shukuo LIU, ZHEJIANG PROVINCE (CN); Yinlu WANG, HENAN PROVINCE (CN)

(21) Appl. No.: 16/660,811

(22) Filed: Oct. 23, 2019

(30) Foreign Application Priority Data
Sep. 24, 2019 (CN) 201910904915.8

(51) Int. Cl. A47J 31/42; A47J 42/38; A47J 31/54

(52) U.S. Cl. CPC A47J 31/42; A47J 31/54; A47J 42/38

(57) ABSTRACT

The present invention discloses a coffee machine with coffee bean grinding function comprising a coffee machine base, a French press is arranged in front of the top of the coffee machine base, the bottom of the French press is movably connected with a cup base in a clamping manner, the cup base is fixedly arranged at the top of the coffee machine base, a hollow central column is mounted on one side of the back of the French press and at the top of the coffee machine base, a lifting device or a cover flipping device matching the opening of the French press is arranged on the central column, a water injection device is mounted on one side of the back of the central column and at the top of the coffee machine base, and a water outlet tube is arranged at the output end of the water injection device.

### BACKGROUND OF THE INVENTION

The present invention relates to the technical field of coffee machines, in particular to a coffee machine with a coffee bean grinding function.

People engaged in coffee machines apply electronic technology to coffee machines to realize the automatic control of the whole process of making coffee, such as powder grinding, powder pressing, powder filling, brewing and residues removal, and create automatic coffee machines. Coffee is one of the most popular drinks in the world. It brings pleasure and excitement to people. With the reform and opening up of our country, Italian espresso, cappuccino, latte and milk coffee, which are the most popular in the world, have also been put on the table of Chinese people, and are loved by more and more people. Coffee machine is an indispensable machine in the process of making coffee.

French press, also known as French-style filter pot and tea maker, is a kind of tea set commonly used in tea drinking. However, the existing French press has no coffee bean grinding function. How to use the coffee machine and the French press reasonably is an important problem to be solved at present. Therefore, it is necessary to invent a coffee machine with a coffee bean grinding function to solve the above problem.

### BRIEF SUMMARY OF THE INVENTION

The purpose of the present invention is to provide a coffee machine with a coffee bean grinding function, so as to solve the problem pointed out in the background of the invention.

In order to realize the above purpose, the present invention adopts the following technical solution: a coffee machine with a coffee bean grinding function, comprising a coffee machine base, wherein a French press is arranged in front of the top of the coffee machine base, the bottom of the French press is movably connected with a cup base in a clamping manner, the cup base is fixedly arranged at the top of the coffee machine base, a hollow central column is mounted on one side of the back of the French press and at the top of the coffee machine base, a lifting device or a cover flipping device matching the opening of the French press is arranged on the central column, a water injection device is mounted on one side of the back of the central column and at the top of the coffee machine base, a water outlet tube is arranged at the output end of the water injection device, the water outlet tube sequentially penetrates through the central column and the lifting device or the cover flipping device and extends to a position below one side of the lifting device or the cover flipping device, a water outlet joint matching the top of the French press is fixedly arranged at the bottom of one side of the lifting device or the cover flipping device, and the output end of the water outlet joint is communicated with the input end of the water outlet tube.

Preferably, the French press comprises a coffee bean grinding cup and a filter screen frame, the filter screen frame is movably clamped in the middle of the cavity of the coffee bean grinding cup, a dry grinding knife is arranged below the filter screen frame, the bottom end of the dry grinding knife is hermetically treated, penetrates through the bottom wall of the coffee bean grinding cup and rotates in the coffee bean grinding cup, a lifting rod is fixedly arranged at the top axis center of the filter screen frame, and the top of the coffee bean grinding cup is movably connected with a cup cover in a clamping manner.

Preferably, a cup belt sleeves the outer wall of the coffee bean grinding cup, the cup belt is made of a heat insulating material and a handle is fixedly arranged on the surface of one side of the cup belt.

Preferably, the lifting device comprises a lifting platform and a lifting motor, the lifting platform is L-shaped, the bottom end of one side of the lifting platform extends into the central column and is movably clamped, the lifting motor is fixedly arranged in the cavity of the central column, a lifting nut is embedded into the bottom of the lifting platform in a penetrating manner, the output end of the lifting motor is connected with the lifting nut through threads, guide sleeves are embedded in the four corners of the bottom of the lifting platform in a penetrating manner, four groups of guide pillars are fixedly arranged in the cavity of the central column, and the top ends of the guide pillars extend into the guide sleeves and are movably clamped.

Preferably, a first cover plate is arranged at the top of the lifting platform in a clamping manner, the first cover plate is fixed on the lifting platform through a bolt, a first top cover is rotatably arranged on one side of the top of the first cover plate, and the side, far away from the rotatable connection side, of the first top cover is connected with the first cover plate through a fastener.

Preferably, the cover flipping device comprises a second cover plate, a second top cover and a first flip cover, the bottom of the second top cover and the top of the second cover plate are fixedly connected through a bolt, the first flip cover is clamped to the top of the second top cover, and the ends of the second cover plate and the first flip cover are rotatably connected with the top of the central column through a rotating shaft by using a hinge.

Preferably, the water injection device comprises a water tank, a support and an electric heating tube, the water tank is movably clamped to the back of the central column, the support is mounted at the bottom of the water tank, the electric heating tube is arranged in the cavity of the coffee machine base, the input end of the electric heating tube is communicated with the output end of the water tank, the output end of the electric heating tube is communicated with the input end of the water outlet tube, and a pressing strip is fixedly arranged at the bottom of the electric heating tube.

Preferably, a storage box is arranged at the top of the water tank in a clamping manner, a second flip cover is rotatably arranged at the top of the storage box, the side, far from the rotatable connection side, of the second flip cover is connected with the storage box through a fastener, and a decoration sheet is fixedly arranged on one side of the storage box.

Preferably, a decoration ring is fixedly connected on the outer side of the coffee machine base in a sleeving manner, a bottom cover is fixedly arranged at the bottom of the coffee machine base through a screw, foot pads are fixedly arranged at the four corners of the bottom of the bottom cover, a power line is fixedly arranged at the top of the bottom cover, and one end of the power line penetrates through the coffee machine base and one sidewall of the decoration ring, extends to the outer wall of the coffee machine base and is connected with an external power wire.

Preferably, a panel is embedded into the front surface of the coffee machine base, the panel penetrates through one side of the decoration ring, a display panel is fixedly arranged on the back of the panel, the display panel is arranged in the cavity of the coffee machine base, the display panel is connected with the panel through a wire, a rotating motor is further arranged in the cavity of the coffee machine base, and the output end of the rotating motor penetrates through the top wall of the coffee machine base and the cup base and is rotatably connected with the bottom of the dry grinding knife.

The present invention has the following technical effects and advantages:

1. By adding the coffee bean grinding function to the existing coffee machine, the coffee beans in the French press can be crushed and mixed through the high-speed rotation of the motor after brewing, and the mixed coffee is enabled to pass through the filter screen frame, and the coffee residues are discharged from the bottom of the filter screen frame to realize the separation of solution and residues.

2. By arranging the central column in the present invention, the supporting connection or reception of the parts at the upper portion of the lifting device or the cover flipping device is facilitated, and the space of the coffee machine is utilized to the utmost extent; by arranging the lifting device or the cover flipping device on the French press in a lifting or flipping manner, the French press can be tightly sealed and the assembly flexibility of the coffee machine can be enabled to be higher at the same time.

### BRIEF DESCRIPTION OF THE DRAWINGS

FIG. 1 is a front cross-sectional structural schematic view of a coffee machine with a lifting device according to the present invention.

FIG. 2 is a side cross-sectional structural schematic view of a coffee machine with a lifting device according to the present invention.

FIG. 3 is an exploded structural schematic view of a coffee machine with a lifting device according to the present invention.

FIG. 4 is a front cross-sectional structural schematic view of a coffee machine with a cover flipping device according to the present invention.

FIG. 5 is a side cross-sectional structural schematic view of a coffee machine with a cover flipping device according to the present invention.

FIG. 6 is an exploded structural schematic view of a coffee machine with a cover flipping device according to the present invention.

In the drawings: 1. coffee machine base; 2. French press; 21. coffee bean grinding cup; 22. filter screen frame; 23. dry grinding knife; 24. lifting rod; 25. cup cover; 26. cup belt; 27. handle; 3. cup base; 4. central column; 5. lifting device; 51. lifting platform; 52. lifting motor; 53. guide pillar; 54. guide sleeve; 55. lifting nut; 56. first cover plate; 57. first top cover; 6. cover flipping device; 61. second cover plate; 62. second top cover; 63. first flip cover; 7. water injection device; 71. water tank; 72. support; 73. electric heating tube; 74. pressing strip; 75. storage box; 76. second flip cover; 77. decoration sheet; 8. water outlet tube; 9. water outlet joint; 10. decoration ring; 11. power line; 12. bottom cover; 13. foot pads; 14. panel; 15. display panel.

### DETAILED DESCRIPTION OF THE INVENTION

The technical solution in the embodiments of the present invention will be clearly and completely described below with reference to the drawings in the embodiments of the present invention. Obviously, the described embodiments are only part of the embodiments of the present invention, not all of the embodiments. Based on the embodiments in the present invention, all other embodiments obtained by one skilled in the art without contributing any inventive labor shall also belong to the protection scope of the present invention.

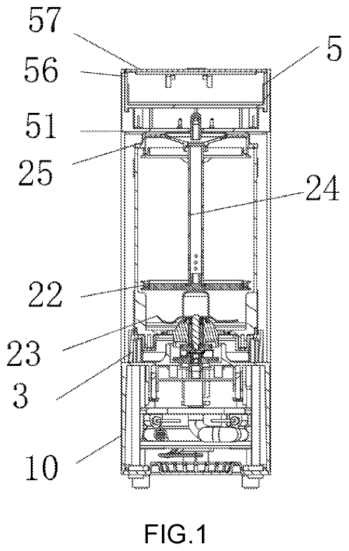

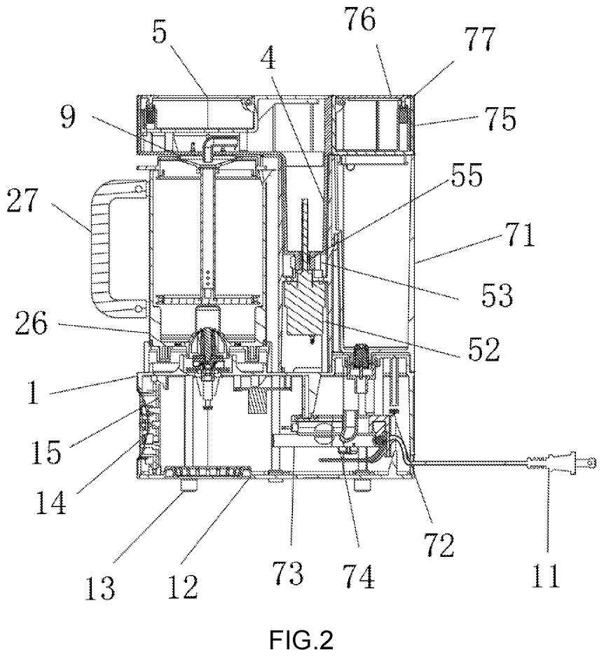

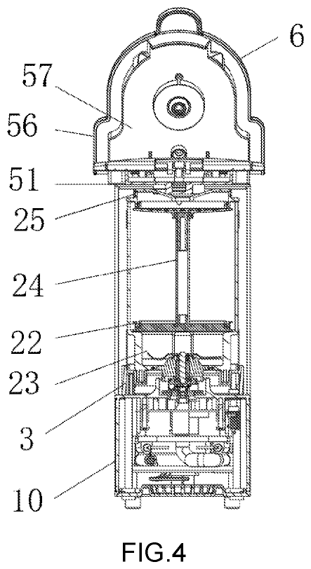

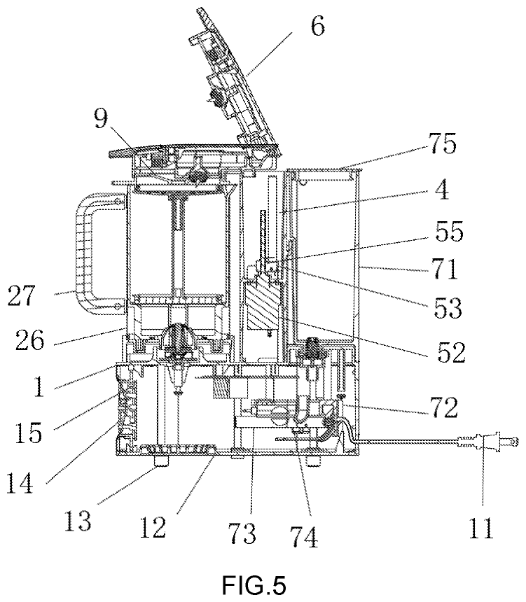

The present invention provides a coffee machine with a coffee bean grinding function as illustrated in FIG. 1 to FIG. 6, comprising a coffee machine base 1, wherein a French press 2 is arranged in front of the top of the coffee machine base 1, the bottom of the French press 2 is movably connected with a cup base 3 in a clamping manner, and the cup base 3 is fixedly arranged at the top of the coffee machine base 1, such that it is convenient to take out the French press 2 from the coffee machine through the cup base 3. Through the arrangement of the French press 2, not only can coffee solution be stored, but also coffee solution can be prepared on the coffee bean grinding site, thus improving the taste of coffee solution. At the same time, the French press 2 can also achieve the separation of residues and solution, thus enabling the existing single-function coffee machine to be a multi-functional coffee machine, and improving the experience of the coffee machine.

In addition, a hollow central column 4 is mounted on one side of the back of the French press 2 and at the top of the coffee machine base 1, and a lifting device 5 or a cover flipping device 6 matching the opening of the French press 2 is arranged on the central column 4. Through the arrangement of the central column 4, the supporting connection or reception of the parts at the upper portion of the lifting device 5 or the cover flipping device 6 is facilitated, and the space of the coffee machine is utilized to the utmost extent. By arranging the lifting device 5 or the cover flipping device 6 on the French press 2, the French press 2 can be tightly sealed and the assembly flexibility of the coffee machine can be enabled to be higher at the same time.

In addition, a water injection device 7 is mounted on one side of the back of the central column 4 and at the top of the coffee machine base 1, pure water required for grinding coffee beans can be stored through the water injection device 7, a water outlet tube 8 is arranged at the output end of the water injection device 7, the water outlet tube 8 sequentially penetrates through the central column 4 and the lifting device 5 or the cover flipping device 6 and extends to a position below one side of the lifting device 5 or the cover flipping device 6, a water outlet joint matching the top of the French press 2 is fixedly arranged at the bottom of one side of the lifting device 5 or the cover flipping device 6, and the output end of the water outlet joint 9 is communicated with the input end of the water outlet tube 8. When grinding beans, the pure water stored in the water injection device 7 is automatically added to the French press 2 through the water outlet tube 8 and the water outlet joint 9.

According to the present embodiment, the French press 2 comprises a coffee bean grinding cup 21 and a filter screen frame 22, and the filter screen frame 22 is movably clamped in the middle of the cavity of the coffee bean grinding cup 21. By arranging the filter screen frame 22, the coffee can be filtered through the filter screen frame 22, the mixed coffee is enabled to pass through the filter screen frame, and the coffee residues are discharged from the bottom to realize the separation of solution and residues. A dry grinding knife 23 is arranged below the filter screen frame 22, the bottom end of the dry grinding knife 23 is hermetically treated, penetrates through the bottom wall of the coffee bean grinding cup 21 and rotates in the coffee bean grinding cup 21, a lifting rod 24 is fixedly arranged at the top axis center of the filter screen frame 22, and the top of the coffee bean grinding cup 21 is movably connected with a cup cover 25 in a clamping manner. Through the arrangement of the dry grinding knife 23, the coffee beans in the coffee bean grinding cup 21 can be crushed through the high-speed rotation of the dry grinding knife 23, and the fineness of the ground coffee beans can be controlled by controlling the rotation speed of the dry grinding knife 23. A cup belt 26 sleeves the outer wall of the coffee bean grinding cup 21, the cup belt 26 is made of a heat insulating material and a handle 27 is fixedly arranged on the surface of one side of the cup belt 26.

A decoration ring 10 is fixedly connected on the outer side of the coffee machine base 1 in a sleeving manner, a bottom cover 12 is fixedly arranged at the bottom of the coffee machine base 1 through a screw, foot pads 13 are fixedly arranged at the four corners of the bottom of the bottom cover 12, a power line 11 is fixedly arranged at the top of the bottom cover 12, and one end of the power line 11 penetrates through the coffee machine base 1 and one sidewall of the decoration ring 10, extends to the outer wall of the coffee machine base 1 and is connected with an external power wire. In addition, a pressing strip 74 is arranged above the part of the power line 11 in the cavity of the coffee machine base 1, and the pressing strip 74 is connected with the power line 11 through a wire that can be disconnected.

A panel 14 is embedded into the front surface of the coffee machine base 1, the panel 14 penetrates through one side of the decoration ring 10, a display panel 15 is fixedly arranged on the back of the panel 14, the display panel 15 is arranged in the cavity of the coffee machine base 1, the display panel 15 is connected with the panel 14 through a wire, a rotating motor is further arranged in the cavity of the coffee machine base 1, and the output end of the rotating motor penetrates through the top wall of the coffee machine base 1 and the cup base 3 and is rotatably connected with the bottom of the dry grinding knife 23.

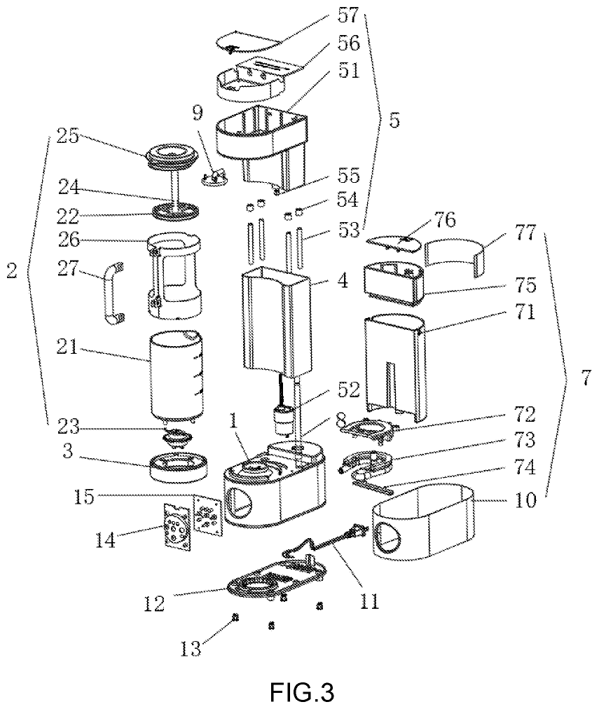

More specifically, in conjunction with FIG. 3, the lifting device 5 comprises a lifting platform 51 and a lifting motor 52, the lifting platform 51 is L-shaped, the bottom end of one side of the lifting platform 51 extends into the central column 4 and is movably clamped, the lifting motor 52 is fixedly arranged in the cavity of the central column 4, a lifting nut 55 is embedded into the bottom of the lifting platform 51 in a penetrating manner, the output end of the lifting motor 52 is connected with the lifting nut 55 through threads, guide sleeves 54 are embedded in the four corners of the bottom of the lifting platform 51 in a penetrating manner, four groups of guide pillars 53 are fixedly arranged in the cavity of the central column 4, and the top ends of the guide pillars 53 extend into the guide sleeves 54 and are movably clamped. By arranging the integral body formed by the guide pillars 53 and guide sleeves 54 at the four corners of the bottom of the lifting platform 51, the stability of the lifting platform 51 can be improved when lifted up or lowered down in the central column 4. Through the above arrangement, when the lifting motor 52 works, the output end rotates and drives the lifting nut 55 to spirally rotate up and down at the output end of the lifting motor 52. Since the lifting nut 55 is fixed at the bottom of the lifting platform 51, the lifting platform 51 can be driven to be lifted up and lowered down through the up-down movement of the lifting nut 55 at the output end of the lifting motor 52, thus realizing the compaction sealing or opening of the French press 2.

In addition, a first cover plate 56 is arranged at the top of the lifting platform 51 in a clamping manner, the first cover plate 56 is fixed on the lifting platform 51 through a bolt, a first top cover 57 is rotatably arranged on one side of the top of the first cover plate 56, and the side, far away from the rotatable connection side, of the first top cover 57 is connected with the first cover plate 56 through a fastener. It is convenient to store some raw materials or additives and other auxiliary supplies through the first cover plate 56.

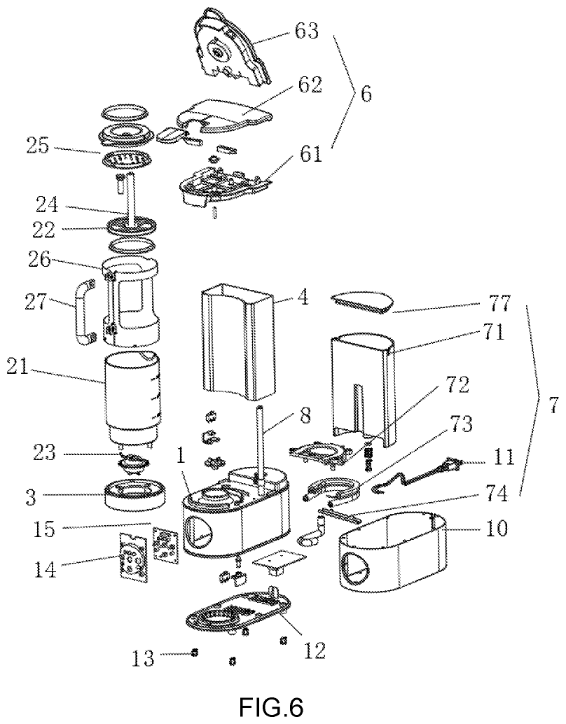

As illustrated in FIG. 6, the cover flipping device 6 comprises a second cover plate 61, a second top cover 62 and a first flip cover 63, the bottom of the second top cover 62 and the top of the second cover plate 61 are fixedly connected through a bolt, the first flip cover 63 is clamped to the top of the second top cover 62, and the ends of the second cover plate 61 and the first flip cover 63 are rotatably connected with the top of the central column 4 through a rotating shaft by using a hinge. Through the above arrangement, the first flip cover 63 on the cover flipping device 6 is lifted by a hand during flipping to make the cover flipping device 6 rotate around the central column 4 at a certain angle to realize the compaction or opening of the French press 2.

In conjunction with FIG. 3 and FIG. 6, the water injection device 7 comprises a water tank 71, a support 72 and an electric heating tube 73, the water tank 71 is movably clamped to the back of the central column 4, the support 72 is mounted at the bottom of the water tank 71, the electric heating tube 73 is arranged in the cavity of the coffee machine base 1, the input end of the electric heating tube 73 is communicated with the output end of the water tank 71, the output end of the electric heating tube 73 is communicated with the input end of the water outlet tube 8, and a pressing strip 74 is fixedly arranged at the bottom of the electric heating tube 73 and is used for supporting the electric heating tube 73 and preventing the heating tube 73 from being in direct contact with the bottom cover 12 and burning out the bottom cover 12. Through the above arrangement, the water in the water tank 71 is heated through the electric heating tube 73, then passes through the water outlet tube 8 and the water outlet joint 9, and enters the coffee bean grinding cup 21.

A storage box 75 is arranged at the top of the water tank 71 in a clamping manner, a second flip cover 76 is rotatably arranged at the top of the storage box 75, the side, far from the rotatable connection side, of the second flip cover 76 is connected with the storage box 75 through a fastener, and a decoration sheet 77 is fixedly arranged on one side of the storage box 75. The water tank 71 is sealed through the decoration sheet 77, and arrangement of the storage box 75 facilitates the storage of some small parts.

More specifically, a depth sensor is fixedly arranged in the water tank 71, and the depth sensor is electrically connected with the display panel 15. In addition, the connection mode between the depth sensor and the display panel 15 is the existing technology, which is not described further here.

Further, the structure and connection mode of the panel 14 and display panel 15 are all existing technologies, and the control program of the panel 15 has been compiled when it leaves the factory, which will not be further disclosed in the present application; moreover, both lifting motor 52 and the rotating motor are parts which have already been disclosed, and the specific structure, control and power supply are also existing mature technologies, which will not be further described in the present application. At the same time, all power supply in the present application is connected and disconnected through electrical connection of the power line 11 with the external power supply.

The working principle of the present invention is as follows:

During working, the coffee machine is firstly mounted according to the above-mentioned embodiment, and the coffee machine with the lifting device 5 as the main body or the coffee machine with the cover flipping device 6 as the main body is selected for use.

Then water is filled into the water tank 71, so that the water in the water tank 71 is heated by the electric heating tube 73, then passes through the water outlet tube 8 and the water outlet joint 9, and enters the coffee bean grinding cup 21.

Then the parts of the coffee machine are controlled to work through the panel 14 and the display panel 15. Firstly, the rotating motor drives the dry grinding knife 23 to rotate at high speed in the coffee bean grinding cup 21 to crush the coffee beans. At the same time, the pure water in the water tank 71 is injected into the French press 2 through the water outlet tube 8 and the water outlet joint 9. When the beans are ground, the rotating speed of the rotating motor can be controlled through the panel 14 and the display panel 15, so as to control the fineness of the coffee beans ground by the dry grinding knife 23.

Finally, it should be noted that the above-mentioned embodiments are just the preferred embodiments of the present invention and are not used to limit the present invention. Although the present invention is described in detail with reference to the above-mentioned embodiments, for one skilled in the art, the technical solution recorded in each of the above-mentioned embodiments may also be modified, or partial technical features may be equivalently replaced. Any modification, equivalent replacement or improvement made within the spirit and principle of the present invention shall be included in the protection scope of the present invention.

What is claimed is:

1. A coffee machine with a coffee bean grinding function, comprising a coffee machine base (1), wherein a French press (2) is arranged in front of the top of the coffee machine base (1), the bottom of the French press (2) is movably connected with a cup base (3) in a clamping manner, the cup base (3) is fixedly arranged at the top of the coffee machine base (1), a hollow central column (4) is mounted on one side of the back of the French press (2) and at the top of the coffee machine base (1), a lifting device (5) or a cover flipping device (6) matching the opening of the French press (2) is arranged on the central column (4), a water injection device (7) is mounted on one side of the back of the central column (4) and at the top of the coffee machine base (1), a water outlet tube (8) is arranged at the output end of the water injection device (7), the water outlet tube (8) sequentially penetrates through the central column (4) and the lifting device (5) or the cover flipping device (6) and extends to a position below one side of the lifting device (5) or the cover flipping device (6), a water outlet joint matching the top of the French press (2) is fixedly arranged at the bottom of one side of the lifting device (5) or the cover flipping device (6), and the output end of the water outlet joint (9) is communicated with the input end of the water outlet tube (8).

2. The coffee machine with the coffee bean grinding function according to claim 1, wherein the French press (2) comprises a coffee bean grinding cup (21) and a filter screen frame (22), the filter screen frame (22) is movably clamped in the middle of the cavity of the coffee bean grinding cup (21), a dry grinding knife (23) is arranged below the filter screen frame (22), the bottom end of the dry grinding knife (23) is hermetically treated, penetrates through the bottom wall of the coffee bean grinding cup (21) and rotates in the coffee bean grinding cup (21), a lifting rod (24) is fixedly arranged at the top axis center of the filter screen frame (22), and the top of the coffee bean grinding cup (21) is movably connected with a cup cover (25) in a clamping manner.

3. The coffee machine with the coffee bean grinding function according to claim 2, wherein a cup belt (26) sleeves the outer wall of the coffee bean grinding cup (21), the cup belt (26) is made of a heat insulating material and a handle (27) is fixedly arranged on the surface of one side of the cup belt (26).

4. The coffee machine with the coffee bean grinding function according to claim 1, wherein the lifting device (5) comprises a lifting platform (51) and a lifting motor (52), the lifting platform (51) is L-shaped, the bottom end of one side of the lifting platform (51) extends into the central column (4) and is movably clamped, the lifting motor (52) is fixedly arranged in the cavity of the central column (4), a lifting nut (55) is embedded into the bottom of the lifting platform (51) in a penetrating manner, the output end of the lifting motor (52) is connected with the lifting nut (55) through threads, guide sleeves (54) are embedded in the four corners of the bottom of the lifting platform (51) in a penetrating manner, four groups of guide pillars (53) are fixedly arranged in the cavity of the central column (4), and the top ends of the guide pillars (53) extend into the guide sleeves (54) and are movably clamped.

5. The coffee machine with the coffee bean grinding function according to claim 4, wherein a first cover plate (56) is arranged at the top of the lifting platform (51) in a clamping manner, the first cover plate (56) is fixed on the lifting platform (51) through a bolt, a first top cover (57) is rotatably arranged on one side of the top of the first cover plate (56), and the side, far away from the rotatable connection side, of the first top cover (57) is connected with the first cover plate (56) through a fastener.

6. The coffee machine with the coffee bean grinding function according to claim 1, wherein the cover flipping device (6) comprises a second cover plate (61), a second top cover (62) and a first flip cover (63), the bottom of the second top cover (62) and the top of the second cover plate (61) are fixedly connected through a bolt, the first flip cover (63) is clamped to the top of the second top cover (62), and the ends of the second cover plate (61) and the first flip cover (63) are rotatably connected with the top of the central column (4) through a rotating shaft by using a hinge.

7. The coffee machine with the coffee bean grinding function according to claim 1, wherein the water injection device (7) comprises a water tank (71), a support (72) and an electric heating tube (73), the water tank (71) is movably clamped to the back of the central column (4), the support (72) is mounted at the bottom of the water tank (71), the electric heating tube (73) is arranged in the cavity of the coffee machine base (1), the input end of the electric heating tube (73) is communicated with the output end of the water tank (71), the output end of the electric heating tube (73) is communicated with the input end of the water outlet tube (8), and a pressing strip (74) is fixedly arranged at the bottom of the electric heating tube (73).

8. The coffee machine with the coffee bean grinding function according to claim 7, wherein a storage box (75) is arranged at the top of the water tank (71) in a clamping manner, a second flip cover (76) is rotatably arranged at the top of the storage box (75), the side, far from the rotatable connection side, of the second flip cover (76) is connected with the storage box (75) through a fastener, and a decoration sheet (77) is fixedly arranged on one side of the storage box (75).

9. The coffee machine with the coffee bean grinding function according to claim 7, wherein a decoration ring (10) is fixedly connected on the outer side of the coffee machine base (1) in a sleeving manner, a bottom cover (12) is fixedly arranged at the bottom of the coffee machine base (1) through a screw, foot pads (13) are fixedly arranged at the four corners of the bottom of the bottom cover (12), a power line (11) is fixedly arranged at the top of the bottom cover (12), and one end of the power line (11) penetrates through the coffee machine base (1) and one sidewall of the decoration ring (10), extends to the outer wall of the coffee machine base (1) and is connected with an external power wire.

10. The coffee machine with the coffee bean grinding function according to claim 2, wherein a panel (14) is embedded into the front surface of the coffee machine base (1), the panel (14) penetrates through one side of the decoration ring (10), a display panel (15) is fixedly arranged on the back of the panel (14), the display panel (15) is arranged in the cavity of the coffee machine base (1), the display panel (15) is connected with the panel (14) through a wire, a rotating motor is further arranged in the cavity of the coffee machine base (1), and the output end of the rotating motor penetrates through the top wall of the coffee machine base (1) and the cup base (3) and is rotatably connected with the bottom of the dry grinding knife (23).

11. The coffee machine with the coffee bean grinding function according to claim 9, wherein a panel (14) is embedded into the front surface of the coffee machine base (1), the panel (14) penetrates through one side of the decoration ring (10), a display panel (15) is fixedly arranged on the back of the panel (14), the display panel (15) is arranged in the cavity of the coffee machine base (1), the display panel (15) is connected with the panel (14) through a wire, a rotating motor is further arranged in the cavity of the coffee machine base (1), and the output end of the rotating motor penetrates through the top wall of the coffee machine base (1) and the cup base (3) and is rotatably connected with the bottom of the dry grinding knife (23).
